(19) United States
(12) Patent Application Publication
(10) Pub. No.: US 2009/0225704 A1
(43) Pub. Date: Sep. 10, 2009

(54) UPLINK TILE INDEX GENERATION APPARATUS AND A UPLINK SUBCHANNEL ALLOCATION APPARATUS OF AN OFDMA SYSTEM

(76) Inventors: Young-Ha Lee, Daejeon-city (KR); Chang-Wahn Yu, Daejeon-city (KR); Jun-Woo Kim, Daejeon-city (KR); Youn-Ok Park, Daejeon-city (KR)

Correspondence Address: Jefferson IP Law, LLP, 1730 M Street, NW, Suite 807, Washington, DC, 20036, US

(21) Appl. No.: 11/721,122

(22) PCT Filed: Dec. 9, 2005
(86) PCT No.: PCT/KR05/04229

§ 371 Date: Jun. 7, 2007

(30) Foreign Application Priority Data
Dec. 11, 2004 (KR) 10-2004-0104628
Aug. 16, 2005 (KR) 10-2005-0074980

(51) Int. Cl. H04W 72/04

(52) U.S. Cl. 370/329

(57) ABSTRACT

A tile index generation apparatus for allocating subchannels of a control channel and a diversity channel, a subchannel allocation apparatus for allocating subchannels of a diversity channel, and a subchannel allocation apparatus for allocating subchannels of an adaptive modulation coding (AMC) channel, which are used for an uplink of an orthogonal frequency division multiplexing access (OFDMA) system, are provided. With these subchannel allocation apparatuses, optimum designs for the uplink subchannel allocation in the OFDM scheme can be provided to a modulator of a subscriber station and a demodulator of a base station, and so the uplink subchannel allocation apparatus has a simple structure and an enhanced transmission speed.

### TECHNICAL FIELD

The present invention relates to an uplink subchannel allocation apparatus used in an orthogonal frequency division multiplexing access system, and more particularly to a tile index generation apparatus for allocating subchannels of a control channel and a diversity channel, a subchannel allocation apparatus for allocating subchannels of a diversity channel, and a subchannel allocation apparatus for allocating subchannels of an adaptive modulation coding (AMC) channel, which are used for an uplink of an orthogonal frequency division multiplexing access (OFDMA) system.

### BACKGROUND ART

In the OFDMA scheme, subchannel and subcarrier allocation are performed so as to divide subscribers according to a state of the subcarriers. The subchannel and the subcarrier allocations are defined as a wireless access standard applied for an IEEE standard 802.16d Wireless MAN-OFDMA physical layer.

In the OFDMA scheme, a subchannel having a plurality of subcarriers is allocated to a subscriber for multiple accesses, and multi-subscriber stations transmit data through the allocated subchannel to a base station.

In this case, different subchannel and subcarrier allocation methods are used according to the respective base station cell IDs provided to the respective base station sectors. This prevents interference between the base stations and also enhances frequency allocation efficiency. In addition, uplink channels are divided into a control channel, a diversity channel, and an adaptive modulation coding (AMC) channel, each respectively having a different subchannel allocation method.

Korean Patent Application No. 2002-0009270 (Feb. 21, 2002) entitled “Pilot carrier allocation method in an orthogonal frequency division multiplexing access system” is incorporated herein by reference.

The above prior art discloses a scheduling method for allocating a pilot carrier so as to perform an OFDMA in an OFDM communication system. In more detail, when a plurality of subscribers simultaneously access a transmit port of the OFDM communication system, the subscribers share pilot carriers with a time interval, rather than the respective subscribers using different pilot carriers allocated for the respective using systems. Accordingly, the same phase error estimating performance as with the access of a single subscriber can be obtained when the number of pilot carriers to be allocated to a single subscriber is increased and simultaneously the plurality of subscribers can gain access.

Meanwhile, Korean Patent Application No. 2002-14334 (Mar. 16, 2002), entitled “Adaptive pilot carrier allocation method and apparatus in an orthogonal frequency division multiplexing access system” is incorporated herein by reference.

The prior art discloses a scheduling method for adaptively allocating a pilot carrier so as to perform an OFDMA in an OFDM communication system. In more detail, the number of pilot carriers that are allocated from a transmit port of the OFDM communication system to the respective systems is adaptively varied according to the state of a subchannel to which the respective pilot carriers are allocated. Accordingly, when the state of the accessed subchannel is good, the number of pilot carriers is reduced thereby minimizing power consumption of the subscriber, and when the state of the accessed subchannel is bad, a channel estimating performance can be preserved even though the power consumption is increased due to the increased number of pilot subcarriers.

Korean Patent Application No. 2003-7007962 (Jun. 13, 2003) entitled “A multi-carrier communication using a group-based subcarrier allocation” is incorporated herein by reference.

The prior art discloses a subcarrier selecting apparatus and method. In more detail, the same spectrum is used for a plurality of adjacent cells in the OFDMA so that intra-cell interference is adaptively allocated to the subcarriers, and also, the subcarriers are adaptively allocated to the subscribers in the OFDMA communication system so that respective subscribers can obtain a high channel gain.

However, the above prior art fails to optimize the definition of a subchannel allocation of an uplink control channel, a diversity channel, and an AMC channel to realize a real design. Accordingly, the prior art has a problem in that a large amount of subchannel allocation and operation must be performed corresponding to the base station cell IDs.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a tile index generation apparatus and an uplink subchannel allocation apparatus having advantages of providing optimum designs for the uplink subchannel allocation in an OFDM scheme to a modulator of a subscriber station and a demodulator of a base station and having a simple structure and an enhanced transmission speed.

### Technical Solution

An exemplary tile index generation apparatus for allocating subchannels of a control channel and a diversity channel in an uplink of an orthogonal frequency division multiplexing access scheme according to an embodiment of the present invention includes:

a first adder for adding lower-order bits of base station cell IDs to tile indexes, the tiles included in a subchannel;

a second adder for adding higher-order bits of the base station cell IDs to the tile index;

a modulo operator for modulo-operating the sum of the lower-order bits of the base station cell IDs and the tile indexes;

a first permutation circulator for circulating a first permutation of the output of the modulo operator;

a second permutation circulator for circulating a second permutation of the output of the second adder;

a third adder for adding higher-order bits of subchannel index numbers to the tile index;

an XOR circuit for selectively performing an exclusive XOR operation of the lower-order bits of the subchannel index numbers and the outputs of the first and second permutation circulators;

a plurality of fourth adders for selectively adding the outputs of the third adder, the outputs of the XOR circuit, and the lower-order bits of the subchannel index numbers;

and a shift register for selectively outputting tile indexes from the outputs of the XOR circuit and the outputs of the plurality of fourth adders based on the higher-order bits and lower-order bits of the base station cell IDs.

In addition, an exemplary subchannel allocation apparatus for allocating subchannels of a diversity channel in an uplink of an orthogonal frequency division multiplexing access scheme according to another embodiment of the present invention includes a first modulo operator for performing a modulo-N operation for a base station ID (c), an operation converter for storing N previously operated results corresponding to the output of the first modulo operator, a first adder for adding subcarriers (n) to the output of the operation converter, and a second modulo operator for performing a modulo-N operation for the outputs of the first adder and outputting a subcarrier index.

In addition, an exemplary subchannel allocation apparatus for allocating subchannels of an uplink adaptive modulation coding channel in an orthogonal frequency division multiplexing access scheme according to another embodiment of the present invention includes:

a first operation converter for outputting a predetermined value based on a range of input base station cell IDs;

a second operation converter for outputting a modulo operation value (per) by a scale (N), which is the range of input base station cell IDs;

a first adder for performing a per+j operation by adding a symbol (j) matched with the subcarrier to the modulo-N operation value (per);

a first modulo operator for performing the modulo-N operation for the outputs of the first adder;

a third operation converter for storing N predetermined operation values and outputting an output of the first modulo operator corresponding to one of the N predetermined operation values;

a second adder for adding the output of the first operation converter to the output of the third operation converter;

first and second function processors for outputting function values corresponding to the outputs of the second adder; and

a shift register for defining subcarrier indexes in the AMC channel by outputting the subcarrier index 0 when the first operation converter outputs 0, and outputting subcarrier indexes through the first and second function processors when the first operation converter does not output 0.

### BRIEF DESCRIPTION OF THE DRAWINGS

FIG. 1 is a block diagram showing a tile configuration, the tile being a standard unit of a subchannel allocation of an OFDMA uplink control channel and a diversity channel

FIG. 2 is a block diagram showing a bin configuration, the bin being a standard unit of a subchannel allocation of an OFDMA uplink AMC channel.

FIG. 3 is a block diagram showing a tile index generator, the tile being a standard unit of a subchannel allocation of an OFDMA uplink control channel and a diversity channel according to an exemplary embodiment of the present invention.

FIG. 4 is a block diagram showing a subchannel allocation apparatus for allocating subchannels of an OFDMA uplink diversity channel according to an exemplary embodiment of the present invention.

FIG. 5 is a block diagram showing a subchannel allocation apparatus for allocating subchannels of an OFDMA uplink AMC channel according to an exemplary embodiment of the present invention.

### MODE FOR THE INVENTION

Exemplary embodiments of the present invention will hereinafter be described in detail with reference to the accompanying drawings.

Hereinafter, a configuration and an operation of an uplink subchannel allocation apparatus of the OFDMA system according to an exemplary embodiment of the present invention is described with reference to the accompanying drawings.

First, an uplink subchannel allocation method disclosed in the above-noted 802.16d Wireless MAN-OFDMA PHY will be described.

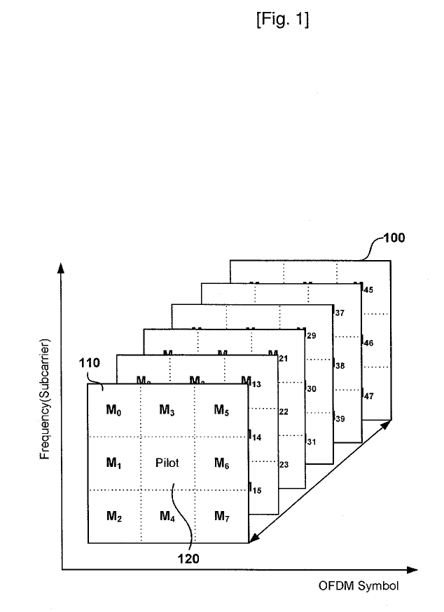

FIG. 1 is a block diagram showing a tile configuration, the tile being a standard unit of a subchannel allocation of an OFDMA uplink control channel and a diversity channel. The control channel and the diversity channel basically have the shape of the tile shown in FIG. 1.

Referring to FIG. 1, in the case of an OFDMA uplink control channel, 6 tiles 100 form one subchannel. Each tile is composed of 3 consecutive subcarriers [symbol] 3 consecutive symbols. Substantially, each of the 6 tiles 100 may include 8 resources M0, M1, M2, M3, M4, M6, and M7, and a pilot 110 having a tone

The 6 tiles may compose various subchannels according to Equation 1, which is called an uplink permutation formula.

$$Tile ( s , m ) = \overline{\{ \begin{matrix} & 0 < {c}_{1} , {c}_{2} < 16 \\ & {c}_{1} \neq 0 , {c}_{2} = 0 \\ & {c}_{1} = 0 , {c}_{2} \neq 0 \\ & {c}_{1} = 0 , = 0\end{matrix}} \qquad ( Equation 1 )$$

In Equation 1, tile (s, m) indicates an m-th tile index in the subchannel s, and it is given that S=s/16 and s′=smod16. Here, m is defined as the tile index in the subchannel. Since 6 tiles are used, m has values 0 to 5, and s indicates a subchannel index number and has values 0 to 47.

In addition, P1,c1(j) indicates a j-th element of a sequence obtained by left-rotating c1 times a basic permutation sequence P1. For example, P1 may become 1, 2, 4, 8, 3, 6, 12, 11, 5, 10, 7, 14, 15, 13, and 9. In addition, P2,c2(j) indicates a j-th element of a sequence obtained by left-rotating c2 times a basic permutation sequence P2. For example, P2 may become 1, 4, 3, 12, 5, 7, 15, 9, 2, 8, 6, 11, 10, 14, and 13. In addition, c1 is given as an (ID cell)mod16, and c2 is given as ID cell/16.

In Equation 1, operations in [ ] are performed on GF (16), and at GF (2n), and an addition becomes a binary XOR operation. For example, at GF (16), 13+4 becomes [(1101)2 XOR (0100)2]=(1001)2=9, wherein (xxxx)2 indicates a binary number format of xxxx.

Therefore, as above noted, the tiles are allocated to the subchannel and the control channel allocates the subcarriers to the respective tiles.

Meanwhile, the subchannel allocation of the diversity channel is performed by indexing the subcarrier included in the 6 tiles as follows.

First, at a first symbol, the subcarriers included in the tile are indexed in a low index order, and then, at second and third symbols, the subcarriers included in the tile are indexed in the same manner. At this time, the subcarrier indexes become 0 to 47.

After being indexed in this manner, data are really mapped with the respective subcarriers according to an order determined by Equation 2.

[symbol]

In Equation 2, n is given as [0, . . . , 47] and c is given as (ID cell)mod48.

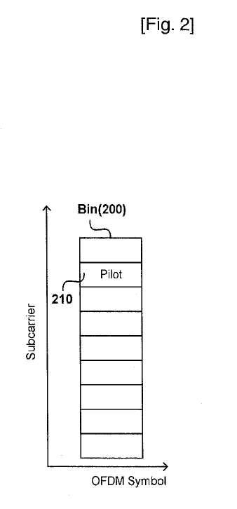

FIG. 2 is a block diagram showing a bin configuration, the bin being a standard unit of a subchannel allocation of an OFDMA uplink AMC channel and having 9 consecutive subcarriers layered on the same symbol.

Referring to FIG. 2, the AMC subchannel is formed with the 9 consecutive bins 200 which exist on the same band. At this time, a pilot subcarrier 210 is placed at a predetermined position that is determined according to the positions of the one bin 200 and the one symbol. The AMC subchannel may be formed with the 6 consecutive bins that exist on the same band.

First, traffic subcarriers are indexed from 0 to 47 in the AMC subchannel. At this time, at a first bin, a first traffic subcarrier index is 0, and a next traffic subcarrier index is 1. At the first bin, all of the mode subcarriers are indexed in this manner. The subcarriers are increasingly indexed along an axis of the subcarriers and then an axis of the bins.

In addition, in a single subchannel, the 6 bins 200 are indexed from the lowest bin index in the first symbol to the highest bin index in the last symbol among the symbols included in the 6 bins 200.

In the single subchannel, the bands are respectively indexed, that is, the bands are increasingly indexed along the bin direction and then increasingly indexed along the symbol axis at the end of the band.

At this time, among 48 symbols in which AMC subchannels are allocated, a j-th symbol is mapped with a (

[symbol]

−1)-th subcarrier, as in Equation 3. In Equation 3,

[symbol]

is a j-th element of a series

[symbol]

, and j is in the range 0 to 47.

$${S}_{per}^{off} ( j ) = \{ \begin{matrix}{P}_{per} ( j ) + off & {P}_{per} ( j ) + off \neq 0 \\ off & {P}_{per} ( j ) + off = 0\end{matrix} \qquad ( Equation 3 )$$

In Equation 3,

[symbol]

indicates a j-th element of a signal series obtained by left-circulating
per
times a basic permutation

### P₀

.

In addition, the

[symbol]

is a basic permutation defined in GF (72) and is expressed in septenary format as 01, 22, 46, 52, 42, 41, 26, 50, 05, 33, 62, 43, 63, 65, 32, 40, 04, 11, 23, 61, 21, 24, 13, 60, 06, 55, 31, 25, 35, 36, 51, 20, 02, 44, 15, 34, 14, 12, 45, 30, 03, 66, 54, 16, 56, 53, 64, and 10.

In addition, it is given that

[symbol]

and [symbol]
, and that
n mod m
indicates a remainder of n?m and [symbol]
indicates a maximum integer which is less than X.

In Equation 3, a formula for obtaining

[symbol]

is defined in GF (72) and uses an operation on GF (72). That is, an addition on GF (72) performs a mod 7 operation for respective chippers. For example, in GF (72), it is given as (56)+(34)=(13), that is, a remainder 1 of (5+3)÷7 is added to a remainder 3 of (6+4)÷7 so that 13 is obtained.

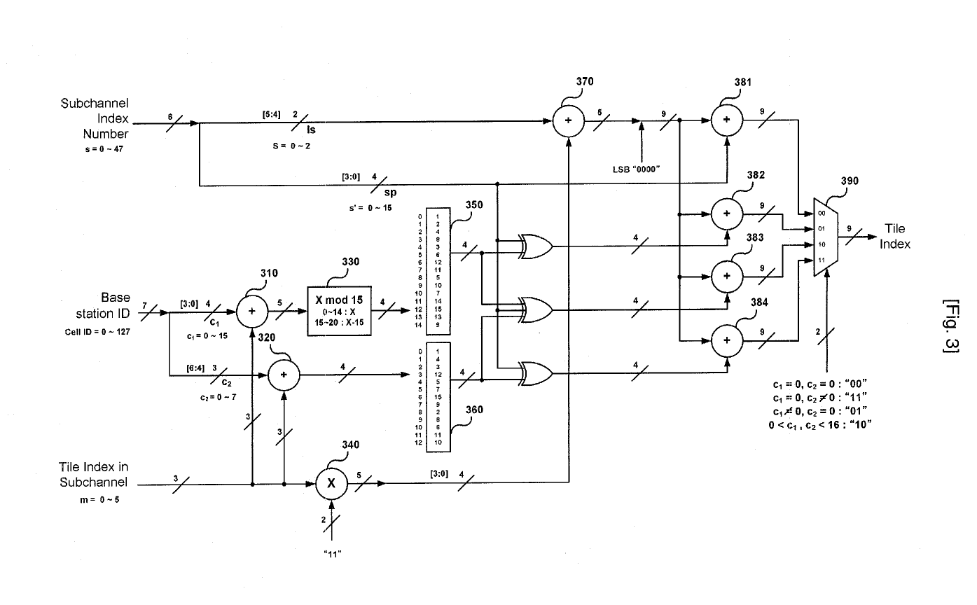

Hereinafter, definitions for a subchannel allocation of an uplink control channel, a diversity channel, and an AMC channel expressed in Equations 1 to 3 according to an exemplary embodiment of the present invention will be described with reference to FIG. 3 to FIG. 5.

FIG. 3 is a block diagram showing a tile index generator, the tile being a standard nit of a subchannel allocation of an OFDMA uplink control channel and a diversity channel according to an exemplary embodiment of the present invention.

Referring to FIG. 3, a tile index generator according to an exemplary embodiment of the present invention includes a first adder 310, a second adder 320, a modulo operator 330, a first multiplier 340, a P1 permutation circulator 350, a P2 permutation circulator 360, three XOR circuits, a third adder 370, fourth to seventh adders 381, 382, 383, and 384, and a shift register 390.

First, tiles, which are a standard unit of a subchannel of a control channel and a diversity channel, are indexed. The tiles are indexed by realizing Equation 1.

Referring to FIG. 3, base station cell IDs are expressed in the range of 0 to 127 by cutting a bit. That is, although the base station cell ID is expressed in a 7 bit format, the base station cell ID may have values 4 bit([3:0]) and 3 bit([6:4]) respectively cut by c1 and c2 of Equation 1. As a result, c1 has values 0 to 15 and c2 has values 0 to 7. In addition, the tile indexes in the subchannel are expressed in a 3 bit format having 0 to 5 as above noted.

Therefore, the first adder 310 adds the cut 4 bit([3:0]) base station cell IDs (c1) to the 3-bit tile indexes (m) and outputs 5-bit values.

The second adder 320 adds the cut 3 bit([6:4]) base station cell ID c2 to the 3-bit tile index (m) and outputs 4-bit values.

The first multiplier 340 multiplies the 3-bit tile index (m) in the subchannel by “11” expressed in a 2 bit format and generates 5-bit values. Thereafter, the 4 bit([3:0]) values are input to the third adder 370.

In addition, the modulo operator 330 15-modulo operates the sum of c1 and m and outputs 4-bit values. This is because the P1 permutation circulator 350 has 15 elements.

In addition, the P2 permutation circulator 360 P2 permutation-circulates the sum of c2 and m. In this case, since the sum of c2 and m has values 0 to 12, the last elements 14 and 13 may be absent among elements of the P2 permutation.

In addition, the 6-bit subchannel index number (s), having values of 0 to 47, is respectively expressed in [5:4] and [3:0]. In this case, S has values 0 to 2 as 2-bit values expressed in the upper order of the subchannel (s) and s′ has values 0 to 15 as 4-bit values expressed in the lower order of each subchannel (s).

The third adder 370 operates 48m+16S. The 48m+16S are utilized while changed into 16(3m+S)

That is, the third adder 370 substantially calculates 3m+S, and the fourth adder 381 receives the 3m+S and expresses 16(3m+S) by multiplying the 3m+S by 16. In this case, the 16(3m+S) may be obtained by left-shifting the 3m+6 by 4 bits. That is, the 16(3m+S) may be obtained by inserting LSB “0000”.

The fourth adder 381 outputs c1=0 and c2=0, and performs 48m+16S+s′.

In addition, the fifth adder 382 adds XOR operation results of the output of the P1 permutation circulator 350 and s′ to the 48m+16S as Equation 1. At this time, c1 is not 0 and c2 is 0.

Likewise, all cases where c1 is 0 and c2 is not 0, or c1 is greater than 0 and c2 is less than 16 can be verified, and Equation 1 may be expressed by FIG. 3.

Ultimately, as shown in FIG. 3, the shift register 390 determines the tiles, which are the standard unit of the subchannel allocation of the uplink control channel and the diversity channel, in 9-bit indexes.

Meanwhile, the control channel may allocate the subcarriers appropriately to the subchannel indexes. However, the diversity channel must allocate the subcarriers as in Equation 2.

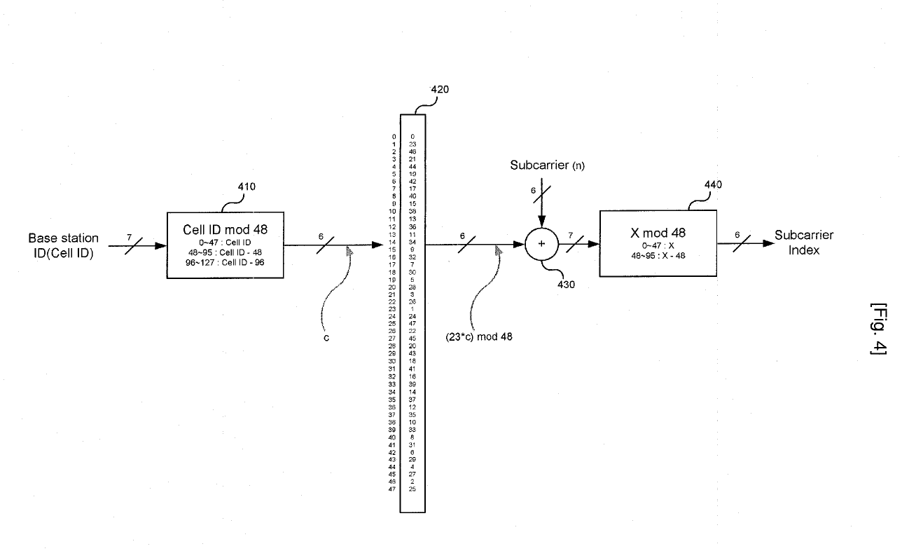

FIG. 4 is a block diagram showing a subchannel allocation apparatus for allocating subchannels of an OFDMA uplink diversity channel according to an exemplary embodiment of the present invention.

Referring to FIG. 4, a subchannel allocation apparatus for allocating subchannels of an OFDMA uplink diversity channel according to an exemplary embodiment of the present invention may include a first modulo operator 410, an operation converter 420, a first adder 430, and a second modulo operator 440.

In more detail, as shown in FIG. 4, Equation 2

[symbol]

is realized when the first modulo operator 410 obtains c. That is, since the first modulo operator 410 modulo-48 operates the base station Cell IDs, the base station Cell IDs 0 to 47 have original values, the base station Cell IDs 48 to 95 respectively have the Cell ID-48, and the base station Cell IDs 96 to 127 respectively have the Cell ID-96.

In addition, in Equation 2, the (n+23c)mod48 may be developed in ((n)mod48+23cmod48)mod48. Using these relations, the operation converter 420 firstly performs (23c)mod48. In this case, c has values 0 to 47, and also the (23c)mod48 has values 0 to 47. Accordingly, the operation converter 420 stores the previously operated values so that the operation converter 420 can output (23c)mod48 when c is input.

In addition, the first adder 430 adds subcarrier (n) to (23c)mod48, and the second modulo operator 440 performs Xmod48 and outputs the 6-bit subcarrier index so that Equation 2 may be realized. Accordingly, the subcarrier indexes are defined in the diversity subchannel using Equation 2, so that the subchannels can be allocated in the diversity channel.

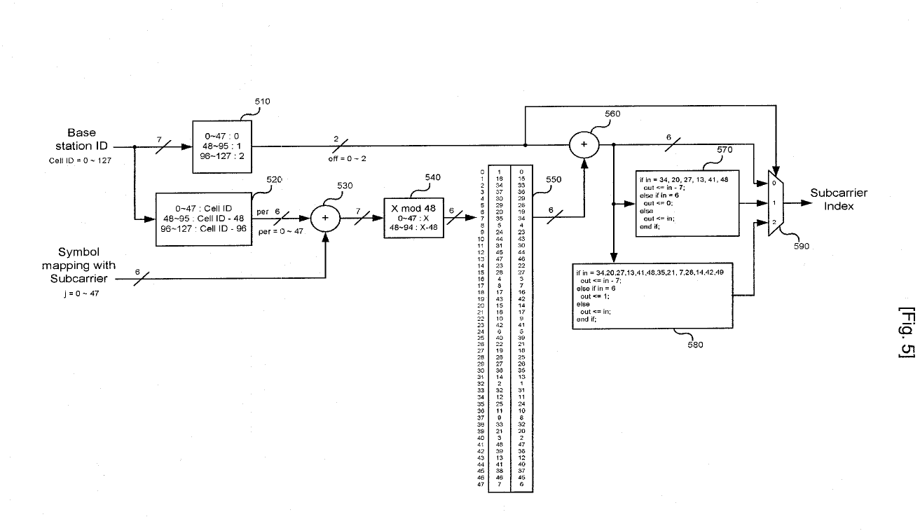

FIG. 5 is a block diagram showing a subchannel allocation apparatus for allocating subchannels of an OFDMA uplink AMC channel according to an exemplary embodiment of the present invention.

Referring to FIG. 5, a subchannel allocation apparatus for allocating subchannels of an OFDMA uplink AMC channel according to an exemplary embodiment of the present invention may include a first operation converter 510, a second operation converter 520, a first adder 530, a first modulo operator 540, a third operation converter 550, a second adder 560, a first function processor 570, a second function processor 580, and a shift register 590.

In more detail, the AMC channel is defined in Equation 3, the first operation converter 510 can express an off of Equation 3, and the second operation converter 520 can express a per of the second operation converter 520.

That is, when the base station Cell IDs 0 to 127 are input, the first operation converter 510 outputs 0 for the base station Cell IDs 0 to 47, and outputs 1 for the base station Cell IDs 48 to 95, and outputs 3 for the base station Cell IDs 96 to 127. In addition, when the base station Cell IDs 0 to 127 are input, the second operation converter 520 outputs the original Cell IDs for the base station Cell IDs 0 to 47, and outputs Cell ID-48 for the base station Cell IDs 48 to 95, and outputs Cell ID-96 for the base station Cell IDs 96 to 127. Therefore, the off becomes 2-bit values having values 0 to 2 and the per has values 0 to 47.

In addition, the first adder 530 outputs 7-bit values by adding a symbol (j) matching with the subcarrier having values 0 to 47 to the per, that is, performing a per+j operation. Thereafter, the per+j left-shifts the P0 permutation. At this time, since the P0 permutation has 48 elements, the first modulo operator 540 performs a modulo-48 operation.

In addition, the third operation converter 550 can convert the 7-bit values to 6-bit values corresponding to the outputs of the first modulo operator 540, since the third operation converter 550 has stored the previously operated GF (72). Thereafter, the second adder 560 adds the converted values to the off.

That is, when the off is given as 0 in Equation 3, the shift register 590 outputs 0 as the subcarrier index. When the off is not given as 0 in Equation 3, the shift register 590 outputs the subcarrier indexes through the operations of the first function processor 570 and the second function processor 580. Accordingly, the subcarrier indexes are defined in the AMC channel, so that the subchannels of the AMC channel can be allocated.

Ultimately, optimum designs for the uplink subchannel allocation in the OFDM scheme according to an exemplary embodiment of the present invention can be provided to a modulator of a subscriber station and a demodulator of a base station.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, the optimum designs for the uplink subchannel allocation in the OFDM scheme can be provided to a modulator of a subscriber station and a demodulator of a base station, and so the uplink subchannel allocation apparatus has a simple structure and an enhanced transmission speed.

1. A tile index generation apparatus for allocating subchannels of a control channel and a diversity channel in an uplink of an orthogonal frequency division multiplexing access scheme, the apparatus comprising:
a first adder for adding lower-order bits of base station cell IDs to tile indexes, the tiles included in a subchannel;
a second adder for adding higher-order bits of the base station cell IDs to the tile index;
a modulo operator for modulo-operating the sum of the lower-order bits of the base station cell IDs and the tile indexes;
a first permutation circulator for circulating a first permutation of the outputs of the modulo operator;
a second permutation circulator for circulating a second permutation of the output of the second adder;
a third adder for adding higher-order bits of subchannel index numbers to the tile index;
a XOR circuit for selectively performing an exclusive XOR operation of the lower-order bits of the subchannel index numbers and the outputs of the first and second permutation circulators;
a plurality of fourth adders for selectively adding the outputs of the third adder, the outputs of the XOR circuit, and the lower-order bits of the subchannel index numbers; and
a shift register for selectively outputting tile indexes from the outputs of the XOR circuit and the outputs of the fourth adder based on the higher-order bits and lower-order bits of the base station cell IDs.

2. The tile index generation apparatus of claim 1, wherein when the base station cell IDs have N-bit values, the N-bit values are input into the first and second adders while being divided into higher-order bit values and lower-order bit values based on divisors of the modulo operator.

3. The tile index generation apparatus of claim 1, wherein the subchannel index numbers (s) have M-bit values, the M-bit values are input into the third and forth adders while being divided into high-order 2-bit values and lower-order bit values.

4. The tile index generation apparatus of claim 1, wherein the shift register outputs the new tile indexes based on the output of the first permutation circulator when the higher-order bit of the base station cell ID is 0,
the shift register outputs the tile indexes based on the output of the second permutation circulator when the lower-order bit of the base station cell ID is 0, and
the shift register outputs the tile indexes based on the outputs of the first and second permutation circulators when both the higher-order bits and the lower-order bits of the base station cell ID are not 0.

5. The tile index generation apparatus of claim 4, wherein the shift register outputs the tile indexes based on the subchannel index numbers and the original tile index numbers, when both the higher-order bits and the lower-order bits are 0.

6. A subchannel allocation apparatus for allocating subchannels of a diversity channel in an uplink of an orthogonal frequency division multiplexing access scheme, comprising
a first modulo operator for performing a modulo-N operation for a base station ID (c);
an operation converter for storing N previously operated results corresponding to the output of the first modulo operator;
a first adder for adding subcarriers (n) to the output of the operation converter; and
a second modulo operator for performing a modulo-N operation for the outputs of the first adder and outputting a subcarrier index.

7. The subchannel allocation apparatus of claim 6, wherein the operation converter previously stores the outputs of the modulo-N operation in which the modulo-N operation value has been multiplied by a predetermined coefficient, the predetermined coefficient being determined according to the base station IDs.

8. A subchannel allocation apparatus for allocating subchannels of an uplink adaptive modulation coding channel in an orthogonal frequency division multiplexing access scheme, the apparatus comprising:
a first operation converter for outputting a predetermined value based on a range of input base station cell IDs;
a second operation converter for outputting a modulo operation value (per) by a scale (N), which is the range of input base station cell IDs;
a first adder for performing a per+j operation by adding a symbol (j) matched with the subcarrier to the modulo-N operation value (per);
a first modulo operator for performing the modulo-N operation for the outputs of the first adder;
a third operation converter for storing N predetermined operation values and outputting an output of the first modulo operator corresponding to one of the N predetermined operation values;
a second adder for adding the output of the first operation converter to the output of the third operation converter;
first and second function processors for outputting function values corresponding to the outputs of the second adder; and
a shift register for defining subcarrier indexes in the AMC channel by outputting the subcarrier index 0 when the first operation converter outputs 0, and outputting subcarrier indexes corresponding to the operation outputs of the first and second function processors when the first operation converter does not output 0.

9. The subchannel allocation apparatus of claim 8, wherein the third operation converter outputs the corresponding symbol (j) matched with the subcarrier from a signal series obtained by circulating per times a predetermined permutation.
